(19) United States
(12) Patent Application Publication
(10) Pub. No.: US 2016/0100129 A1
(43) Pub. Date: Apr. 7, 2016

(54) METHOD FOR CONVERTING FRAME RATE AND IMAGE OUTPUTTING APPARATUS THEREOF

(71) Applicant: SAMSUNG ELECTRONICS CO., LTD., Suwon-si (KR)

(72) Inventor: Dae-sung IM, Suwon-si (KR)

(21) Appl. No.: 14/851,058

(22) Filed: Sep. 11, 2015

(30) Foreign Application Priority Data
Oct. 2, 2014 (KR) 10-2014-0133484

(51) Int. Cl. H04N 7/01

(52) U.S. Cl. CPC H04N 7/0137

(57) ABSTRACT

A method for converting a frame rate and an image outputting apparatus thereof are provided. The frame rate conversion method includes: receiving a plurality of images having a first frame rate; generating an interpolation frame with respect to at least one image from among the plurality of images, converting the first frame rate into a second frame rate with respect to the at least on image, and converting the first frame rate into the second frame rate by generating a repetitive frame with respect to the other images except for the at least one image from among the plurality of images; and outputting a plurality of images which are converted into the second frame rate through a single screen.

### CROSS-REFERENCE TO RELATED APPLICATION

This application is based on and claims priority under 35 U.S.C. §119 to a Korean patent application filed on Oct. 2, 2014 in the Korean Intellectual Property Office and assigned Serial No. 10-2014-0133484, the disclosure of which is hereby incorporated by reference in its entirety.

### TECHNICAL FIELD

Apparatuses and methods consistent with example embodiments relate to a method for converting a frame rate and an image outputting apparatus thereof, and for example, to a method for converting a frame rate, which converts a frame rate by performing motion compensation with respect to only a certain area and repeatedly outputting the other areas, and an image outputting apparatus.

### BACKGROUND

With the advancement of electronic technology, an image outputting apparatus which displays various image inputs simultaneously is provided. In the case of a smart TV, a UI for providing a function of controlling the image outputting apparatus may be displayed on a part of a screen in addition to the input image.

In addition, a recent image outputting apparatus applies technology of driving at 120 Hz to 240 Hz rather than at existing 60 Hz. In this case, the image outputting apparatus converts a frame rate of an input image of 60 Hz into 120 Hz or 240 Hz (Frame Rate Conversion (FRC)). The image outputting apparatus may reduce image blur or jitter by generating an interpolation frame when converting the frame rate.

However, compared with the case in which a single image is received and processed, in the case in which a plurality of image inputs are outputted though a single screen, when motion is compensated by generating an interpolation frame and a frame rate is converted, the motion is normally processed only in a certain area. This is because the screen configured by the plurality of image inputs is recognized as a single image and the frame rate is converted.

Therefore, there is a need to compensate for a motion by dividing an area of a single screen to which a plurality of images are input. In a related-art method, with respect to all input images, motion compensation is performed independently. However, motion compensation is performed for a part which does not require motion compensation, and thus there is a problem that the amount of data processed in the image outputting apparatus increases. In addition, the related-art method also has a problem that a user cannot set an area to be subject to motion compensation.

### SUMMARY

One or more example embodiments may overcome the above disadvantages and other disadvantages not described above.

One or more example embodiments provide a method for converting a frame rate, which sets a certain area with respect to a multi-screen configuration input image, performs motion compensation with respect to the set area and converts a frame rate with respect to the set area, and converts a frame rate with respect to the other areas by repeatedly outputting, and an image outputting apparatus.

According to an aspect of an example embodiment, a method for converting a frame rate of an image outputting apparatus is provided, including: receiving a plurality of images having a first frame rate; generating an interpolation frame with respect to at least one image from among the plurality of images, converting the first frame rate of the at least one image having the interpolation frame into a second frame rate, and converting the first frame rate of the other images into the second frame rate by generating a repetitive frame with respect to the other images except for the at least one image from among the plurality of images; and outputting a plurality of images which are converted into the second frame rate through a single screen.

Converting may include: storing frames of the plurality of input images having the first frame rate; converting the first frame rate into the second frame rate by reading out the stored frames of the plurality of images according to an FRC schedule; converting the first frame rate into the second frame rate by reading out the stored frames of the plurality of images repeatedly; and mixing the plurality of images which are converted from the first frame rate into the second frame rate by reading out the frames according to the FRC schedule, with the plurality of images which are converted from the first frame rate into the second frame rate by reading out the frames repeatedly.

The method may further include compensating for motion by generating an interpolation frame with respect to at least one image from among the plurality of images mixed.

Converting may include: storing frames of the plurality of images having the first frame rate; reading out the stored frames of the plurality of images according to an FRC schedule, generating an interpolation frame, and converting the first frame rate of the images having the generated interpolation frame into the second frame rate; reading out the stored frames of the plurality of images repeatedly to convert the first frame rate into the second frame rate; and mixing the plurality of images which have the generated interpolation frame and have been converted into the second frame rate, with the plurality of images which are converted from the first frame rate into the second frame rate by reading out the frames repeatedly.

Mixing the plurality of images may include using frames which are read out according to the FRC schedule with respect to at least one image from among the plurality of images, and using frames which are read out repeatedly with respect to the other images except for the at least one image from among the plurality of images.

The method may further include selecting at least one image from among the plurality of images, and selecting may include selecting based on a user input or selecting based on image formation.

Selecting may include, when at least one of the plurality of images is output from a graphic domain of an application, selecting in a certain form based on a user input.

The image information may be at least one of motion vector information, film information, panning information, pattern information, fallback information, and scene change information.

Converting may include extracting a motion vector with respect to at least one of the plurality of images, and generating an interpolation frame using the extracted motion vector.

The method may further include selecting two or more images from among the plurality of images, and the converting may include processing the selected two or more images as separate areas, and extracting a motion vector from each of the areas.

According to an aspect of another example embodiment, an image outputting apparatus is provided, including: image input circuitry configured to receive a plurality of images having a first frame rate; FRC circuitry configured to generate an interpolation frame with respect to at least one image from among the plurality of images, to convert the first frame rate of the at least one image having an interpolation frame into a second frame rate, and to convert the first frame rate of the other images into the second frame rate by generating a repetitive frame with respect to the other images except for the at least one image from among the plurality of images; and image output circuitry configured to output a plurality of images which are converted from the first frame rate into the second frame rate through a single screen.

The image outputting apparatus may further include a storage configured to store frames of the plurality of input images having the first frame rate, and the FRC circuitry may be configured to convert from the first frame rate into the second frame rate by reading out the stored frames of the plurality of images according to an FRC schedule, to convert from the first frame rate into the second frame rate by reading out the stored frames of the plurality of images repeatedly, and to mix the plurality of images which are converted from the first frame rate into the second frame rate by reading out the frames according to the FRC schedule, with the plurality of images which are converted from the first frame rate into the second frame rate by reading out the frames repeatedly.

The FRC circuitry may be configured to compensate for motion by generating an interpolation frame with respect to at least one image from among the plurality of images.

The image outputting apparatus may further include a storage configured to store frames of the plurality of images having the first frame rate, and the FRC circuitry may be configured to read out the stored frames of the plurality of images according to an FRC schedule, to generate the interpolation frame, and to convert the first frame rate of the images including the interpolation frame into the second frame rate, configured to read out the stored frames of the plurality of images repeatedly and convert first frame rate into the second frame, and configured to mix the plurality of images which have the generated interpolation frame and are converted from the first frame rate into the second frame rate, with the plurality of images which are converted from the first frame rate into the second frame rate by reading out the frames repeatedly.

The FRC circuitry may be configured to mix the plurality of images using frames which are read out according to the FRC schedule with respect to at least one image from among the plurality of images, and use frames which are read out repeatedly with respect to the other images except for the at least one image from among the plurality of images.

The image outputting apparatus may further include user input circuitry configured to receive a user input, and the FRC circuitry may be configured to select at least one image from among the plurality of images based on a user input, or select based on image formation.

When at least one of the plurality of images is output from a graphic domain of an application, the FRC circuitry may be configured to select a certain form based on a user input input.

The image information may be at least one of motion vector information, film information, panning information, pattern information, fallback information, and scene change information.

The FRC circuitry may be configured to extract a motion vector with respect to at least one of the plurality of images, and generate the interpolation frame using the extracted motion vector.

The FRC circuitry may be configured to select two or more images from among the plurality of images, process the selected two or more images as separate areas, and extract a motion vector from each of the areas.

According to various example embodiments as described above, motion compensation may be performed with reference to a specific image from among a plurality of input images, and thus motion jitter can be reduced and/or prevented from occurring in the other images. In addition, an area to be subject to motion compensation can be freely set, and the method of outputting simply by repeating is applied to the areas which are not set, so that efficient frame rate conversion and motion compensation can be achieved.

### BRIEF DESCRIPTION OF THE DRAWINGS

The above and other aspects, features, and advantages of certain example embodiments will become more apparent from the following description taken in conjunction with the accompanying drawings, in which like reference numerals refer to like elements, and wherein:

FIG. 1 is a schematic block diagram illustrating a configuration of an image outputting apparatus according to an example embodiment;

FIG. 2 is a block diagram illustrating a configuration of an image outputting apparatus in detail according to an example embodiment;

FIG. 3 is a view illustrating a frame rate conversion process according to an example embodiment;

FIGS. 4A and 4B are views illustrating reading out frames according to a Frame Rate Conversion (FRC) schedule and reading out frames repeatedly according to an example embodiment;

FIGS. 5A to 5C are views illustrating a process of compensating for a motion by generating an interpolation frame according to an example embodiment;

FIG. 6 is a view illustrating a frame rate conversion process according to an example embodiment;

FIG. 7 is a view illustrating a frame rate conversion process according to an example embodiment; and

FIGS. 8 to 10 are flowcharts illustrating a frame rate conversion method according to various example embodiments.

### DETAILED DESCRIPTION

Example embodiments will be described in greater detail with reference to the accompanying drawings. In the following description, well-known functions or constructions are not described in detail since they would obscure the disclosure with unnecessary detail. Also, the terms used herein are defined according to the functions of the example embodiments. Thus, the terms may vary depending on user's or operator's intention and usage. That is, the terms used herein will be understood based on the descriptions made herein.

The terms “first”, “second”, etc. may be used to describe diverse components, but the components are not limited by the terms. The terms are only used to distinguish one component from the others.

The terms used in the disclosure are only used to describe the example embodiments, but are not intended to limit the scope of the disclosure. The singular expression also includes the plural meaning as long as it does not conflict with the meaning in context. In the disclosure, the terms “include” and “consist of” designate the presence of features, numbers, steps, operations, components, elements, or a combination thereof that are written in the specification, but do not exclude the presence or possibility of addition of one or more other features, numbers, steps, operations, components, elements, or a combination thereof.

In the example embodiments of the disclosure, a “module” or a “unit” performs at least one function or operation, and may be implemented with hardware, software, or a combination of hardware and software. In addition, a plurality of “modules” or a plurality of “units” may be integrated into at least one module except for a “module” or a “unit” which has to be implemented with specific hardware, and may be implemented with at least one processor (not shown). For example, as will be appreciated by those skilled in the art, the described systems, methods and techniques may be implemented in digital electronic circuitry including, for example, electrical circuitry, logic circuitry, hardware, computer hardware, firmware, software, or any combinations of these elements. Apparatus embodying these techniques may include appropriate input and output devices, a computer processor, and a computer program product tangibly embodied in a non-transitory machine-readable storage device or medium for execution by a programmable processor. A process embodying these techniques may be performed by a programmable hardware processor executing a suitable program of instructions to perform desired functions by operating on input data and generating appropriate output. The techniques may be implemented in one or more computer programs that are executable on a programmable processing system including at least one programmable processor coupled to receive data and instructions from, and transmit data and instructions to, a data storage system, at least one input device, and at least one output device. Each computer program may be implemented in a high-level procedural or object-oriented programming language or in assembly or machine language, if desired; and in any case, the language may be compiled or interpreted language. Suitable processors include, by way of example, both general and special purpose microprocessors. Generally, a processor will receive instructions and data from a read-only memory and/or a random access memory. Non-transitory storage devices suitable for tangibly embodying computer program instructions and data include all forms of computer memory including, but not limited to, non-volatile memory, including by way of example, semiconductor memory devices, such as Erasable Programmable Read-Only Memory (EPROM), Electrically Erasable Programmable Read-Only Memory (EEPROM), and flash memory devices; magnetic disks, such as internal hard disks and removable disks; magneto-optical disks; Compact Disc Read-Only Memory (CD-ROM), digital versatile disk (DVD), Blu-ray disk, universal serial bus (USB) device, memory card, or the like. Any of the foregoing may be supplemented by, or incorporated in, specially designed hardware or circuitry including, for example, application-specific integrated circuits (ASICs) and digital electronic circuitry. Thus, methods for providing image contents described above may be implemented by a program including an executable algorithm that may be executed in a computer, and the program may be stored and provided in a non-transitory computer readable medium.

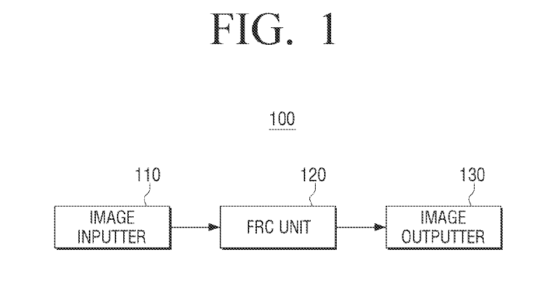

FIG. 1 is a schematic block diagram illustrating a configuration of an image outputting apparatus 100 according to an example embodiment. Referring to FIG. 1, the image outputting apparatus 100 includes an image inputter 110 or image input circuitry, an FRC unit 120 or FRC circuitry, and an image outputter 130 or image output circuitry. The image outputting apparatus 100 may be implemented in various forms such as a TV, a monitor, a tablet PC, a smartphone, a Set-Top Box (STB), or the like. The image outputting apparatus 100 may provide a multi-view. The multi-view refers to outputting a plurality of different input images through a single screen.

The image inputter 110 may receive a plurality of images. The image inputter 110 may receive the plurality of images in the form of image signals or image data. The image inputter 110 may receive images having various resolutions. For example, the resolution of a 2K image is 1920×1080, the resolution of a 4K image is 3840×2160, the resolution of an 8K image 7680×4320, and the resolution of a panorama 4K image is 7680×1080.

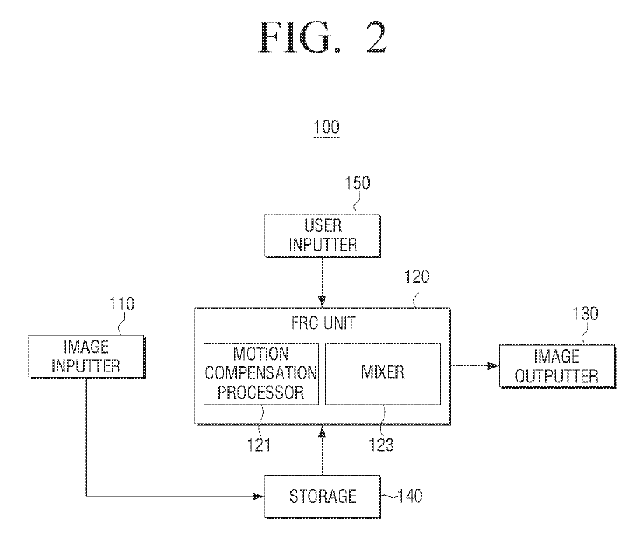

The image inputter 110 may receive a plurality of images having a first frame rate and forwards the images to the FRC unit 120. In addition, the image inputter 110 may not directly forward the images to the FRC unit 120 and may forward the images to the FRC unit 120 through a storage 140 as illustrated and discussed, for example, with respect to FIG. 2 below.

The FRC unit 120 converts the frame rate of the input images. The FRC unit 120 converts the images having a first frame rate into images having a second frame rate. For example, the FRC unit 120 may convert input images having a frame rate of 60 Hz to have a frame rate of 120 Hz to 240 Hz, and output the images.

According an example embodiment, the FRC unit 120 may generate an interpolation frame with respect to at least one of the plurality of input images having the first frame rate, and convert the first frame rate of the ate least one of the plurality of input images into the second frame rate. In addition, the FRC unit 120 may convert the first frame rate into the second frame rate by generating a repetitive frame with respect to the other images except for the at least one image from among the plurality of images having the first frame rate.

The FRC unit 120 may convert the first frame rate into the second frame rate by reading out the frames of the plurality of images having the first frame rate according to an FRC schedule. The FRC schedule refers, for example, to a method of reading out each frame a predetermined number of times repeatedly prior to converting the frame rate. For example, when the frame rate is converted with four frames 1-2-3-4, making 10 frames, a 3:2 pull down method may be adopted as the FRC schedule. In this case, the frame rate may be converted, for example, by reading out the frames in order of 1-1-1-2-2-3-3-3-3-4-4 according to the FRC schedule. In addition, the FRC unit 120 may convert the first frame rate into the second frame rate by reading out the frames of the plurality of images having the first frame rate repeatedly. For example, in the case of four frames 1-2-3-4, the frame rate may be converted by increasing the rate by two times by repeatedly reading out like 1-1-2-2-3-3-4-4.

For example, the FRC unit 120 mixes images, the frame rate of which is converted into the second frame rate, by reading out the frames of the plurality of images in two methods. The FRC unit 120 mixes the images using the images, the frame rate of which is converted by reading out frames according to the FRC schedule with respect to at least one image from among the plurality of images, and using the images, the frame rate of which is converted by repeatedly reading out frames with respect to the other images except for at least one image from among the plurality of images. The FRC unit 120 uses the frames which are read out according to the FRC schedule with respect to image parts which should be subject to motion compensation by generating an interpolation frame. Since the other image parts do not suffer from jitter even if motion compensation is not performed, the FRC unit 120 uses the frames which are simply read out repeatedly with respect to the other image parts. By doing so, the FRC unit 120 may omit an unnecessary motion compensation process for the other image parts.

The FRC unit 120 performs motion compensation with respect to at least one of the plurality of mixed images by generating an interpolation frame. The FRC unit 120 may extract a motion vector by analyzing a difference between a previous frame and a current frame constituting at least one image of the plurality of images. In addition, the FRC unit 120 generates an interpolation frame using the extracted motion vector, and substitutes a frame with the generated interpolation frame. By doing so, the FRC unit 120 may output a smoother image through the motion compensation process.

The FRC unit 120 may perform motion compensation with respect to two or more images which are distanced from each other or are different from each other. When a motion vector is extracted by processing the two or more images together, an appropriate motion vector may not be extracted from both the two or more images due to interference by the different input images. Therefore, the FRC unit 120 may process the two or more images as separate areas, and extract a motion vector from each area.

According to another example embodiment, the FRC unit 120 may read out the frames of the plurality of images having the first frame rate according to the FRC schedule, and then may perform motion compensation prior to mixing the images with the images read out repeatedly. The FRC unit 120 may perform motion compensation by extracting a motion vector with respect to the frames read out according to the FRC schedule and generating an interpolation frame. The FRC unit 120 may perform motion compensation with respect to all of the plurality of images, or may partially perform motion compensation with respect to at least one of the plurality of images. Thereafter, the FRC unit 120 mixes the images which have undergone the motion compensation process and the images the frame rate of which is converted into the second frame rate by reading out repeatedly.

The image outputter 130 or output circuitry outputs the images which are processed by the FRC unit 120. The image outputter 130 outputs the plurality of images, the frame rate of which is converted into the second frame rate, through a single screen. In this case, the image outputter 130 may display the processed images in a visual form using a display, or may output the images to an external device (for example, a TV) using a terminal.

As described above, the image outputting apparatus 100 can reduce and/or prevent jitter which may be caused by performing the frame rate conversion and motion compensation, simultaneously, with respect to the plurality of input images. In addition, the motion compensation is performed for only a part of the images which need motion compensation, so that the resources of the image outputting apparatus 100 can be efficiently managed.

FIG. 2 is a detailed block diagram illustrating a configuration of an image outputting apparatus 100 according to an example embodiment. Referring to FIG. 2, the image outputting apparatus 100 includes an inputter 110 or input circuitry, an FRC unit 120 or FRC circuitry, an image outputter 130 or output circuitry, a storage 140, and a user inputter 150 or input circuitry. In addition, the FRC unit 120 includes a motion compensation processor 121 and a mixer 123.

The image inputter 110 may receive an image signal, image data, etc. from various external sources. The image inputter 110 may receive a broadcast signal such as a TV broadcast signal as an image signal, or may receive an image from a recording medium reproducing apparatus. The recording medium reproducing apparatus refers, for example, to an apparatus which reproduces various kinds of recording media such as a CD, a DVD, a hard disk, a Blu-ray disk, a memory card, a USB memory, or the like, or an image stored in a recording medium.

The image inputter 110 may include a plurality of tuners to receive a plurality of images in order to provide a multi-view. For example, the image inputter 110 may include four tuners to process four broadcast signals in order to receive four kinds of TV channels simultaneously.

The image inputter 110 may receive the plurality of images having a first frame rate and forward the images to the FRC unit 120. Alternatively, the image inputter 110 may not directly forward the input images to the FRC unit 120 and may forward the images to the FRC unit 120 through the storage 140.

The image outputter 130 outputs the image signals which have been processed by the FRC unit 120.

According to an example embodiment, the image outputter 130 outputs the plurality of images which are converted from the first frame rate into the second frame rate through a single screen. The image outputter 130 may display the processed images in a visual form using a display. In addition, when the image outputting apparatus 100 is without a display, such as, for example, a set-top box (STB), the image outputter 130 may output the images to an external device through a wired terminal or wireless communication. The storage 140 stores the frames of the input images. The storage 140 stores the frames of the images such that the FRC unit 120 reads out the stored frames and converts the frame rate. In addition, the storage 140 may store a previous frame with respect to time and compare the previous frame with a current frame. By doing so, motion vector information may be extracted.

The user inputter 150 allows the image outputting apparatus 100 to receive, for example, a user command. For example, the user inputter 150 may be a keypad, a touch screen, a mouse, a remote controller, etc. According to an example embodiment, the user inputter 150 may receive a user input to select at least one image from among the plurality of images.

The FRC unit 120 converts the frame rate of the input images. The FRC unit 120 distinguishes between one image and the other images from among the plurality of input images, and converts the frame rate in different methods. When the plurality of input images are similar in view of their characteristics, all of the images are considered to be a single image and the frame rate is converted by an existing method. However, when the plurality of input images are different in view of their characteristics, undesirable jitter may occur on the screen even if frame rate conversion or motion compensation is performed, and thus, as in the example embodiments, the FRC unit 120 divides the plurality of input images and performs frame rate conversion and motion compensation in different methods. When, for example, one of the plurality of images has a fast moving object and the other images have an object which hardly moves, it is determined that the plurality of input images are different in view of their characteristics.

The FRC unit 120 may generate an interpolation frame with respect to at least one of the plurality of images, and convert the first frame rate into a second frame rate with respect to the at least one of the plurality of images having an interpolation frame, and convert the first frame rate into the second frame by generating a repetitive frame with respect to the other images except for the at least one image from among the plurality of images.

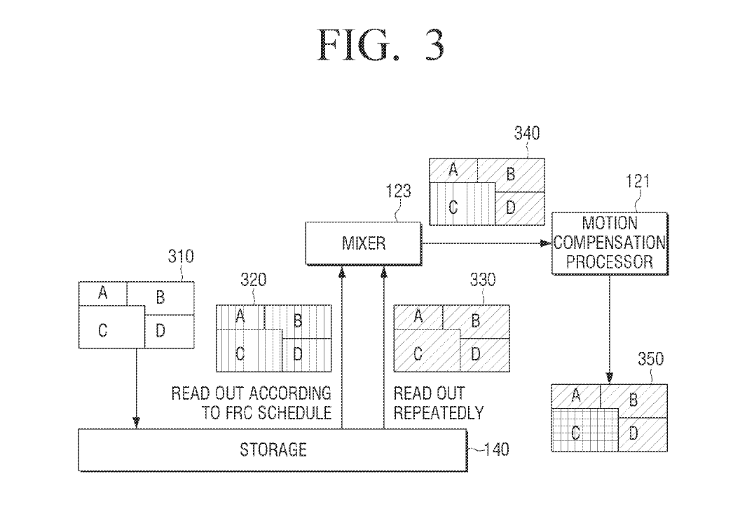

The operation of the FRC unit 120 will be explained in detail below with reference to FIGS. 3 to 7.

FIG. 3 is a view illustrating an example frame rate conversion process of the image outputting apparatus 100 according to an example embodiment. First, an image 310 including a plurality of images A, B, C, D is input. The frames of the plurality of images 310 having a first frame rate are stored in the storage 140. In another example, the input images 310 may be directly forwarded to the FRC unit 120 without passing through the storage 140. For convenience of explanation, it is assumed that the C image from among the plurality of images is an image part which needs to be subject to motion compensation. In this case, the C image may be a movie image which has a source image of 24 Hz and is filmed to make an input image of 60 Hz. In the case of the filmed image, when the frame rate is converted simply by reading out repeatedly, there is a high possibility that jitter may occur and thus it is difficult to expect smooth screen output.

FIG. 3 illustrates an example embodiment in which the frames which are read out in two methods are mixed and then motion compensation is performed. In this example, the FRC unit 120 converts the frame rate of the plurality of images stored in the storage 140 into the second frame rate by reading out the images according to an FRC schedule. For example, when the image having the frame rate of 60 Hz is converted into the image having the frame rate of 120 Hz, the FRC unit 120 reads outs two times more frames than the number of stored frames. The images read out according to the FRC schedule are input to the mixer 123 which is an element of the FRC unit 120. The mixer 123 may be provided separately from the FRC unit 120 and is not necessarily provided as an element of the FRC unit 120.

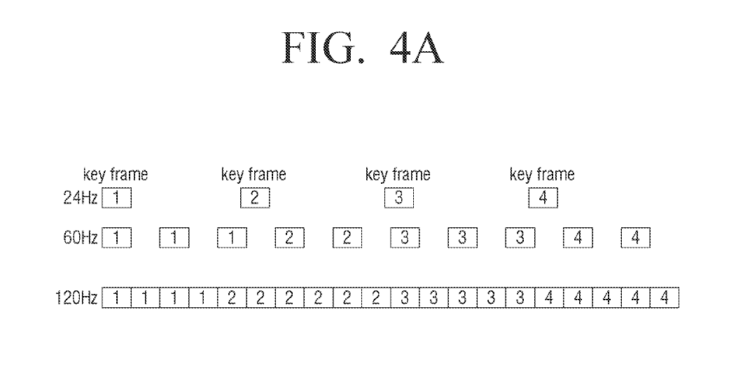

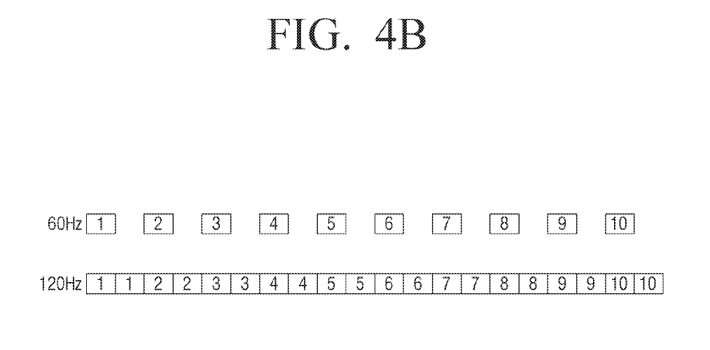

FIG. 4A is a view to illustrate reading out frames according to an FRC schedule. Since the representative example of reading out frames according to an FRC schedule is a movie image, the movie image will be explained by way of an example. In FIG. 4A, the frames shown on the top are frames of images having the frame rate of 24 Hz, which are used for producing a movie. The images input through the image inputter 110 are images having a frame rate of 60 Hz, which are shown in the middle. The input images having the frame rate of 60 Hz may be generated by repeating a key frame such as an original frame of a source having the frame rate of 24 Hz in a specific pattern. Reviewing the frames of the images having the frame rate of 60 Hz shown in the middle of FIG. 4A, four key frames are arranged at a ratio of 3:2:3:2. When the frame rate is converted into 120 Hz simply by reading out the input images of 60 Hz repeatedly, the number of times of output between the key frames increases and thus jitter may occur. In order to reduce and/or prevent this problem, the FRC unit 120 reads out the frames using the FRC schedule which repeats the key frames in a specific schedule pattern. The frames shown on the bottom of FIG. 4A are frames of images which are read out according to the FRC schedule and thus are converted into the frame rate of 120 Hz. The FRC schedule shown in FIG. 4A is merely an example and is not limited.

Referring to FIG. 3, in addition to the images 320 read out according to the FRC schedule, the FRC unit 120 generates images 330 which are converted into the second frame rate by reading out the frames of the plurality of stored images repeatedly. Performing motion compensation with respect to an image which has no serious problem in viewing even when frames are simply outputted repeatedly is inefficient from the aspect of resource management. For example, in the case of an Explorer UI screen in a smart TV, when frames are repeatedly used, there is a low possibility of occurrence of jitter in viewing.

FIG. 4B is a view illustrating reading out frames repeatedly.

As shown in FIG. 4B, general images created at 60 Hz differ from the movie image of FIG. 4A in that key frames are not repeatedly generated many times. As shown in FIG. 4B, the FRC unit 120 may generate images having the frame rate of 120 Hz by reading out the frames of the images having the frame rate of 60 Hz repeatedly two times for each frame.

Referring to FIG. 3, the mixer 123 mixes the images 320 read out according to the FRC schedule and the images 330 read out repeatedly. Specifically, with respect to the image (C) to be subject to motion compensation, the mixer 123 obtains the “C” image part from the images 320 read out according to the FRC schedule, and, with respect to the other images (A, B, D), the mixer 123 obtains the other image parts (A, B, D) from the images 330 read out repeatedly, and mixes the images. The mixer 123 transmits mixed images 340 to the motion compensation processor 121.

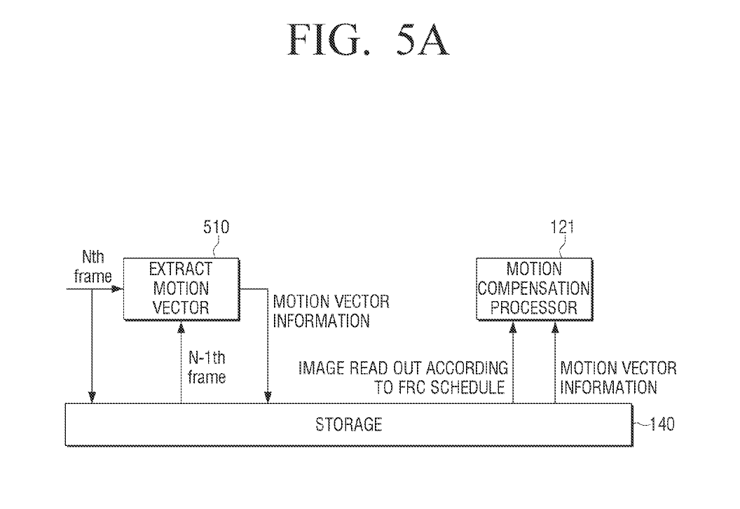

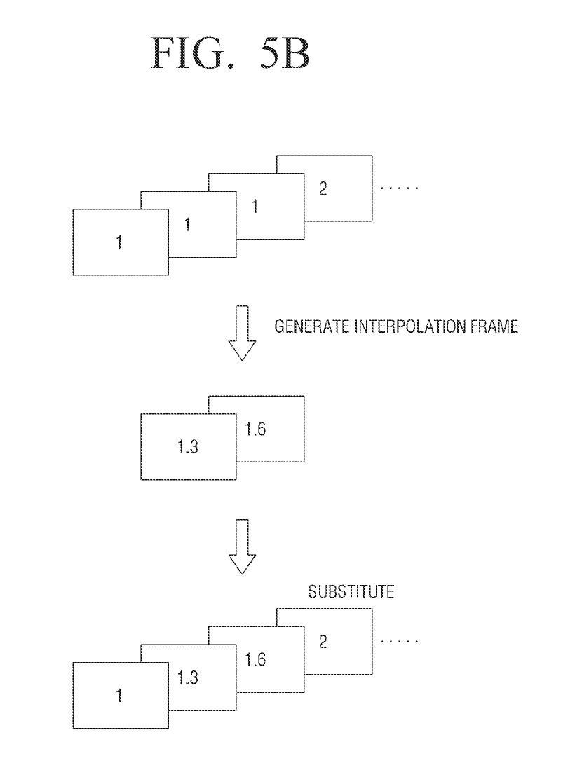

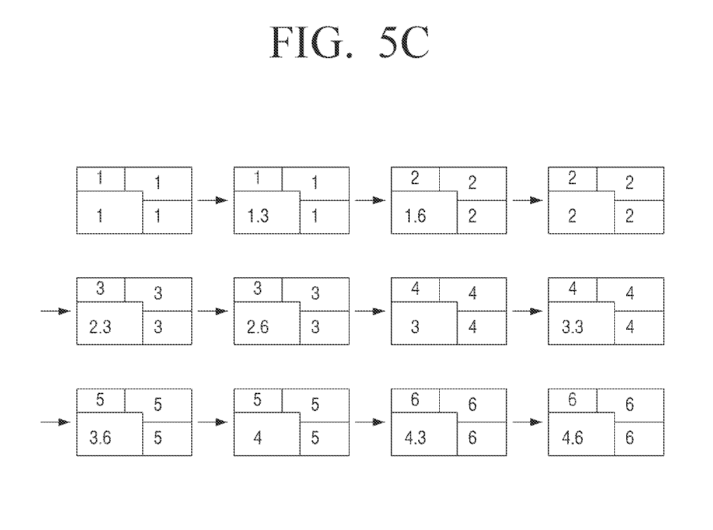

The motion compensation processor 121 performs motion compensation with respect to only the part (C) read out according to the FRC schedule in the mixed images 340, generating output images 350. Compared with the input images 310, the output images 350 have the second frame rate and at least one image (C) from among the plurality of images (A, B, C, and D) is subject to the motion compensation. The operation of the motion compensation processor 121 will be explained in detail with reference to FIGS. 5A to 5C.

FIG. 5A is a view schematically showing a motion vector extraction method according to an example embodiment. The Nth frame of input images is stored in the storage 140 and simultaneously is input to a functional block 510, for example, circuitry configured to extract a motion vector. In addition, the N-1th frame stored in the storage 140 is input to the functional block 510 to extract the motion vector. Based on the previous and current frames, the functional block 510 extracts motion vector information by determining, for example by calculating, the degree of change in the location of an object on the screen and the direction of change. The functional block 510 may be implemented as a separate element, or may be implemented as one element of the image inputter 110 or the FRC unit 120. The motion vector information extracted in the functional block 510 is stored in the storage 140. The motion compensation processor 121 receives the motion vector information from the storage 140 and generates an interpolation frame based on the motion vector information.

FIG. 5B is a view illustrating an example of generating an interpolation frame in the motion compensation processor 121. The motion compensation processor 121 generates the interpolation frame using motion vector information extracted based on frame ‘1’ and frame ‘2.’ In FIG. 5B, it can be seen that frame ‘1’ is read out repeatedly three times and then frame ‘2’ is read out. Therefore, the motion compensation processor 121 performs motion compensation by generating two interpolation frames to be substituted for the two middle frames ‘1’. In FIG. 5B, reference numerals ‘1.3’ and ‘1.6’ used for the two interpolation frames mean that the location of an object in the frame is between the location in frame ‘1’ and the location in frame ‘2.’ Frame ‘1.3’ is an interpolation frame closer to frame ‘1’ and frame ‘1.6’ is an interpolation frame closer to frame ‘2’. The motion compensation processor 121 completes the motion compensation by substituting existing frames with the interpolation frames.

FIG. 5C illustrates frames of mixed images after motion compensation is performed for some image and frame rate conversion is performed. With respect to the frame of the image on the left lower end from among the plurality of images, the motion compensation processor 121 generates an interpolation frame and substitutes the existing frame with the interpolation frame. The FRC unit 120 increases the frame rate by two times by reading out the frames of the other images repeatedly.

A method for selecting at least one image to be read out according to an FRC schedule from among a plurality of images, as shown in FIG. 3, will be explained. According to an example embodiment, the FRC unit 120 may, for example, select at least one image from among the plurality of images based on a user input. For example, the user may select an area through which a movie image is output from among all of the screens, and may control the image outputting apparatus to perform motion compensation with respect to only the corresponding part. When at least one image is selected from among the plurality of images through the user input, only the adjacent images are not necessarily selected. In addition, the image is not necessarily selected in a rectangular shape like a normal image screen. In this selection, the degree of freedom is one of the aspects of the present disclosure. When at least one image of the plurality of images is output from a graphic domain of an application, the FRC unit 120 may select an area to be subject to motion compensation in a certain form through a user input.

According to another example embodiment, the FRC unit 120 may select at least one image from among the plurality of images based on image information even when there is no user input. The image information which is a criterion for determining in the FRC unit 120 may include motion vector information, film information, panning information, pattern information, fallback information, and scene change information. The motion vector information is information on the direction or size of a motion of an object in a screen, which is extracted by comparing a previous frame and a current frame. The panning information is information on the degree of movement of the entire screen. The pattern information is information which is obtained by analyzing a pattern to determine whether there is a repetitive output in the screen. The fallback information is alternative information which is applied when it is impossible to extract the motion vector. The scene change information is information indicating whether a scene of an image is changed to another scene when a frame is changed. The above-described motion vector information, panning information, pattern information, fallback information, and scene change information are screen change information indicating the degree of change in the screen caused when all of the frames are changed. As the change of the screen increases, the need for motion compensation increases. Therefore, the screen change information may be a determination criterion of the FRC unit 120.

In addition, the film information is information indicating whether an input image is an image originally having the normal frame rate of 60 Hz, or an image which is converted once from a source having the frame rate of 24 Hz into the frame rate of 60 Hz. Movie images are mostly produced to have the frame rate of 24 Hz. Therefore, when the movie images are collectively processed with a source having the normal frame rate of 60 Hz when the frame rate is converted, jitter may occur.

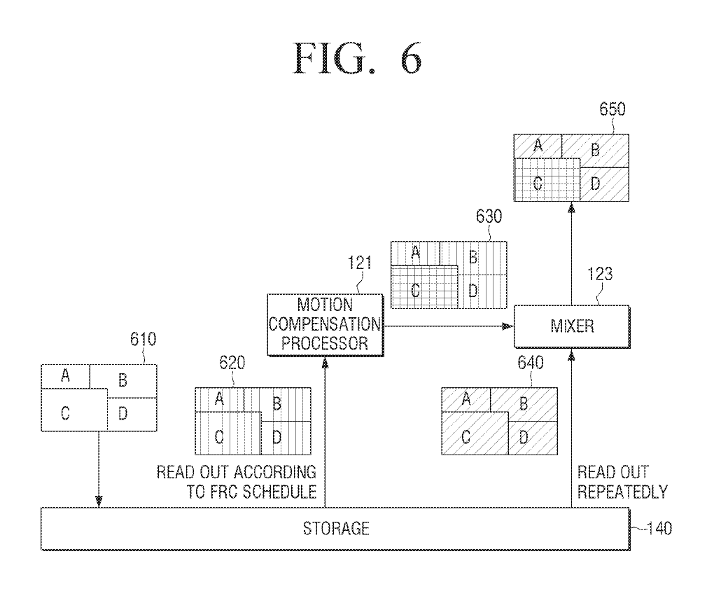

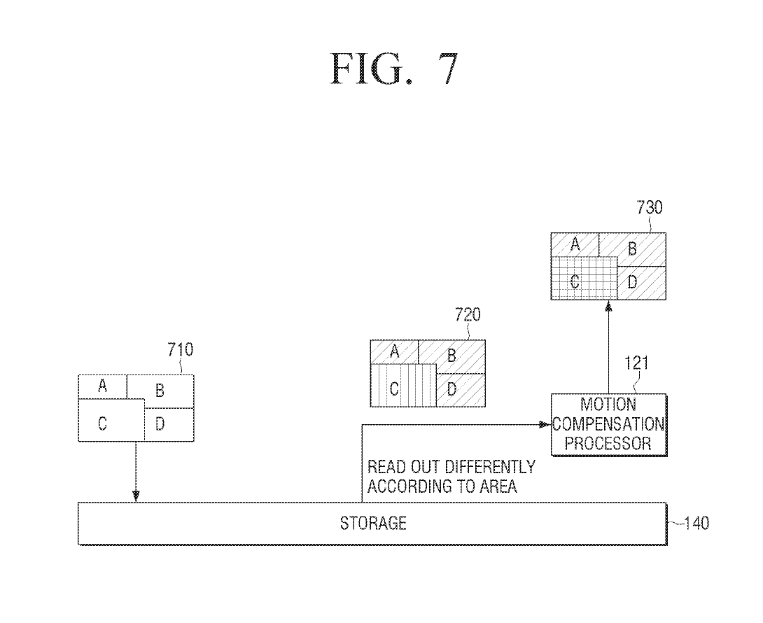

A frame rate conversion process of an image outputting apparatus 100 according to another example embodiment will be explained with reference to FIGS. 6 and 7.

FIG. 6 illustrates an example embodiment in which frames read out according to an FRC schedule are motion-compensated and are then mixed with frames repeatedly read out. It is assumed for convenience of explanation that image C is subject to motion compensation from among a plurality of input images (A, B, C, D). The FRC unit 120 generates images 620 having a second frame rate by reading out frames from the storage 140, in which input images 610 are stored, according to the FRC schedule. The images 620 including the frames read out according to the FRC schedule are input to the motion compensation processor 121. The motion compensation processor 121 performs motion compensation with respect to at least one image (C) from among the plurality of images (A, B, C, D). The motion compensation processor 121 generates images 630 which are motion-compensated by generating an interpolation frame. The FRC unit 120 generates images 640 having the second frame rate by reading out the frames of the input images 610 repeatedly. The mixer 123 generates output images 650 by mixing the motion-compensated images 630 and the repeatedly read-out images 640. The mixer 123 generates the output images 650 using the images 640 in which the frames are repeatedly read out with respect to the other images (A, B, D) except for the motion-compensated image (C).

FIG. 7 illustrates an example embodiment in which frames are read out from the storage 140 differently depending on an area. According to an example embodiment shown in FIG. 7, the process of reading out is reduced by half and thus there is an advantage that consumption of resources of the image outputting apparatus 100 is reduced. Specifically, the FRC unit 120 reads out different frames for each image when reading out a plurality of images stored in the storage 140. When the frames are read out from the top of the entire screen serially, the FRC unit 120 generates images 720 by reading out frames repeatedly in areas A, B, D, and by reading out frames according to an FRC schedule in area C. As a result, the same images as the images 340 generated by reading out the two methods and mixing are obtained, but this method is more efficient since the FRC unit 120 obtains the same result through only a single reading-out process.

As described above, an area to be subject to motion compensation can be freely set through the image outputting apparatus 100, and the method of outputting simply by repeating is applied to the areas which are not set, so that efficient frame rate conversion and motion compensation can be achieved.

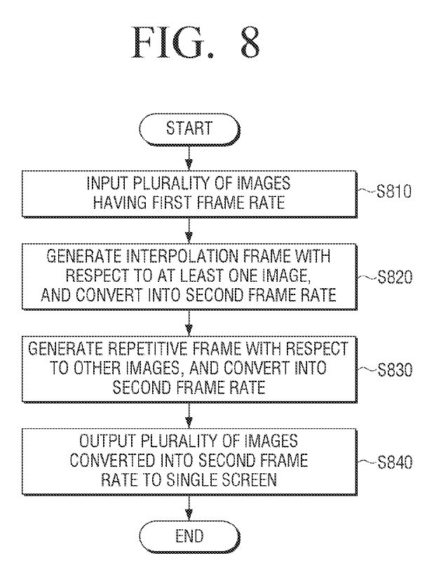

A frame rate conversion method according to various example embodiments will be explained with reference to FIGS. 8 to 10.

FIG. 8 is a flowchart illustrating a frame rate conversion method according to an example embodiment. The image outputting apparatus 100 receives a plurality of images having a first frame rate (S810). The plurality of images may, for example, include a movie image, an image of a TV signal, an application execution screen image, a UI image, etc. Since each image has a different characteristic, the image outputting apparatus 100 divides the plurality of images and converts the frame rate in different methods.

The image outputting apparatus 100 generates an interpolation frame with respect to at least one image of the plurality of images, and converts the frame rate into a second frame rate (S820). For example, the image outputting apparatus 100 converts the frame rate into the second frame rate by reading out frames with respect to at least one of the plurality of images according to an FRC schedule, and performs motion compensation by generating the interpolation frame. In addition, the image outputting apparatus 100 converts the first frame rate of the other images into the second frame rate by generating a repetitive frame with respect to the other images except for the at least one image from among the plurality of images (S830). The image outputting apparatus 100 converts the frame rate of the other images into the second frame rate by reading out the frames of the other images repeatedly. Since operation S830 does not need to be performed after operation S820, operation S830 may be performed before operation S820 or may be performed at the same time as operation S820.

Thereafter, the image outputting apparatus 100 outputs the plurality of images the frame rate of which has been converted into the second frame rate through a single screen (S840). The image outputting apparatus 100 mixes the at least one image, the frame rate of which is converted into the second frame rate from among the plurality of images, with the other images, the frame rate of which is converted into the second frame rate, and outputs the mixed images through a single screen.

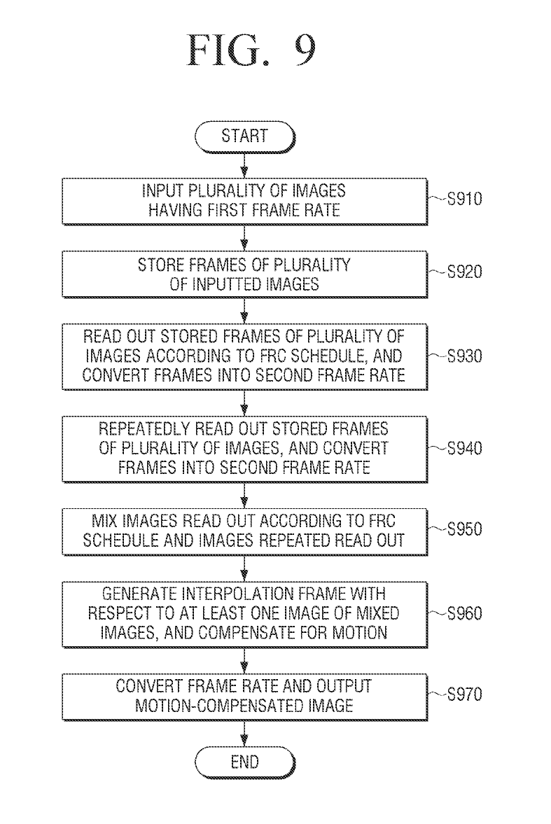

FIG. 9 is a flowchart illustrating a frame rate conversion method according to another example embodiment. The image outputting apparatus 100 receives a plurality of images having a first frame rate (S910). The image outputting apparatus 100 stores frames of the plurality of input images (S920). The stored frames are used to convert the frame rate and used to extract motion vector information.

The image outputting apparatus 100 converts the first frame rate into a second frame rate by reading out the frames of the plurality of images according to an FRC schedule (S930). In addition, the image outputting apparatus 100 converts the first frame rate into the second frame rate by reading out the frames of the plurality of images repeatedly (S940). Operations S930 and S940 do not necessarily have a temporal order relationship, and operation S940 may precede operation 930 or two operations may be performed in parallel.

The image outputting apparatus 100 mixes the plurality of images which are converted into the second frame rate by reading out according to the FRC schedule, with the plurality of images which are converted into the second frame rate by reading out repeatedly (S950). The image outputting apparatus 100 uses the frames read out according to the FRC schedule for the at least one image from among the plurality of images, and uses the frames repeatedly read out for the other images except for the at least one image from among the plurality of images.

The image outputting apparatus 100 may select at least one of the plurality of images when mixing the images. For example, the image outputting apparatus 100 may select at least one of the plurality of images through a user input. When the image is selected through the user input, an area to be subject to motion compensation is determined in each image unit on the entire screen. However, when at least one image from among the plurality of images is output from a graphic domain of an application, the image outputting apparatus 100 may select only some area from the one image in a certain form through the user input.

In another example, the image outputting apparatus 100 may select an area to be subject to motion compensation based on image information of each of the plurality of images without a user input. The image information, which is a selection criterion of the image outputting apparatus 100, may be at least one of motion vector information, film information, panning information, pattern information, fallback information, and scene change information.

Thereafter, the image outputting apparatus 100 performs motion compensation by generating an interpolation frame with respect to at least one of the mixed images (S960). In addition, the image outputting apparatus 100 outputs the plurality of images which undergoes the frame rate conversion and the motion compensation through a single screen (S970). When the motion compensation is performed, the image outputting apparatus 100 extracts a motion vector with respect to at least one of the plurality of images, and generates the interpolation frame using the extracted motion vector. When two or more images are selected from among the plurality of images, the image outputting apparatus 100 processes the two or more images as separate areas and separately perform motion compensation. That is, the image outputting apparatus 100 extracts the motion vector for each area and performs motion compensation.

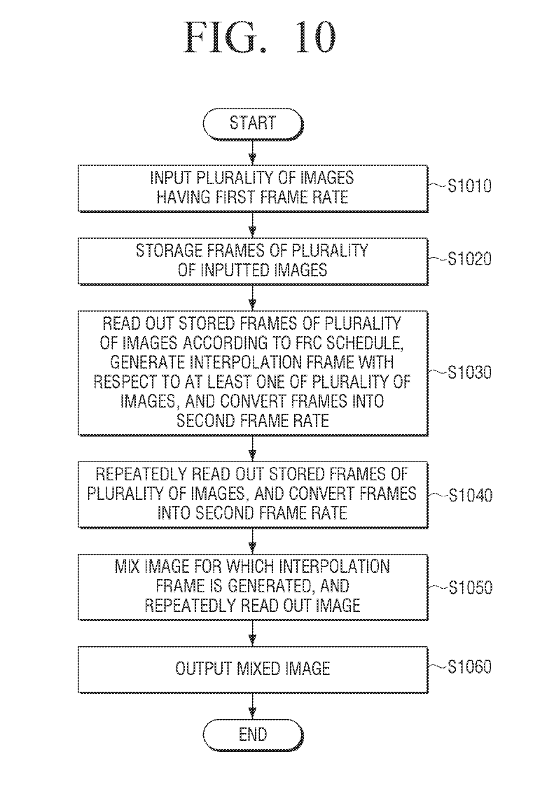

FIG. 10 is a flowchart illustrating a frame rate conversion method according to another example embodiment. The frame rate conversion method of FIG. 10 differs from the method of FIG. 9 in that the motion compensation operation precedes the mixing operation. This difference will be described below.

An operation of receiving a plurality of images having a first frame rate in the image outputting apparatus (S1010), and an operation of storing the frames of the plurality of input images (S1020) correspond to operations S910 and S920 of FIG. 9, thus a detailed description is omitted.

The image outputting apparatus 100 reads outs the frames of the plurality of images according to the FRC schedule, generates an interpolation frame with respect to at least one of the plurality of images, and generates images which are converted into a second frame rate (S1030). In this case, at least one of the plurality of images is processed in the method as described above. After performing the motion compensation with the frames read out according to the FRC schedule, the image outputting apparatus 100 generates images which are converted into the second frame rate by reading out the frames of the plurality of images repeatedly (S1040).

The image outputting apparatus 100 generates output images by mixing the images in which the interpolation frame is generated and the images read out repeatedly (S1050). That is, the image outputting apparatus 100 mixes the images which are converted to have the second frame rate by reading out according to the FRC schedule, and have at least one image subject to motion compensation in operation S1030, and the images which are converted to have the second frame by reading out repeatedly in operation S1040. Regarding an image requiring motion compensation, the image outputting apparatus 100 obtains a corresponding part from the images generated in step S1030, and, regarding the other images, obtains a corresponding part from the images generated in step S1040, and mixes the images. The image outputting apparatus 100 outputs the mixed images (S1060).

Through the frame rate conversion method according to various example embodiments described above, motion compensation is performed with reference to a specific image from among a plurality of input images, and thus motion jitter can be reduced and/or prevented from occurring in the other images.

In addition, a program code for performing the frame rate conversion method according to various example embodiments as described above may be stored in various kinds of recording media. Specifically, the program code may be stored in various kinds of recording media from which data is readable in a terminal, such as a Random Access Memory (RAM), a flash memory, a Read Only Memory (ROM), an Erasable Programmable ROM (EPROM), an Electronically Erasable and Programmable ROM (EEPROM), a register, a hard disk, a removable disk, a memory card, a USB memory, and a CD-ROM.

The foregoing example embodiments and advantages are merely illustrative and are not to be construed as limiting the disclosure. The example embodiments can be readily applied to other types of apparatuses. Also, the description of the example embodiments is intended to be illustrative, and not to limit the scope of the claims, and many alternatives, modifications, and variations will be apparent to those skilled in the art.

What is claimed is:

1. A method for converting a frame rate of an image outputting apparatus, the method comprising:
receiving a plurality of images having a first frame rate;
generating an interpolation frame with respect to at least one image from among the plurality of images, converting the first frame rate into a second frame rate with respect to the at least one image having an interpolation frame, and converting the first frame rate into the second frame rate by generating a repetitive frame with respect to the other images except for the at least one image from among the plurality of images; and
outputting a plurality of images which are converted into the second frame rate through a single screen.

2. The method of claim 1, wherein converting comprises:
storing frames of the plurality of input images having the first frame rate;
converting from the first frame rate into the second frame rate by reading out the stored frames of the plurality of images according to an FRC schedule;
converting from the first frame rate into the second frame rate by reading out the stored frames of the plurality of images repeatedly; and
mixing the plurality of images which are converted into the second frame rate by reading out the frames according to the FRC schedule, with the plurality of images which are converted into the second frame rate by reading out the frames repeatedly.

3. The method of claim 2, further comprising compensating for motion by generating an interpolation frame with respect to at least one image from among the plurality of images mixed.

4. The method of claim 1, wherein converting comprises:
storing frames of the plurality of images having the first frame rate;
reading out the stored frames of the plurality of images according to an FRC schedule, generating the interpolation frame, and converting from the first frame rate into the second frame rate;
reading out the stored frames of the plurality of images repeatedly and converting from the first frame rate into the second frame rate; and
mixing the plurality of images having the generated interpolation frame and converted into the second frame rate, with the plurality of images which are converted into the second frame rate by reading out the frames repeatedly.

5. The method of claim 2, wherein mixing the plurality of images comprises using frames which are read out according to the FRC schedule with respect to at least one image from among the plurality of images, and using frames which are read out repeatedly with respect to the other images except for the at least one image from among the plurality of images.

6. The method of claim 1, further comprising selecting at least one image from among the plurality of images,
wherein the selecting comprises selecting based on one of a received user input or selecting based on image formation.

7. The method of claim 6, wherein selecting comprises, when at least one of the plurality of images is output from a graphic domain of an application, selecting in a certain form based on a received user input.

8. The method of claim 6, wherein the image information is at least one of motion vector information, film information, panning information, pattern information, fallback information, and scene change information.

9. The method of claim 1, wherein converting comprises extracting a motion vector with respect to at least one of the plurality of images, and generating the interpolation frame using the extracted motion vector.

10. The method of claim 9, further comprising selecting two or more images from among the plurality of images,
wherein converting comprises processing the selected two or more images as separate areas, and extracting a motion vector from each of the areas.

11. An image outputting apparatus comprising:
image input circuitry configured to receive a plurality of images having a first frame rate;
FRC circuitry configured to generate an interpolation frame with respect to at least one image from among the plurality of images, to convert the first frame rate into a second frame rate with respect to the at least one image, and to convert the first frame rate into the second frame rate by generating a repetitive frame with respect to the other images except for the at least one image from among the plurality of images; and
image output circuitry configured to output a plurality of images which are converted into the second frame rate through a single screen.

12. The image outputting apparatus of claim 11, further comprising a storage configured to store frames of the plurality of input images having the first frame rate, and
wherein the FRC circuitry is configured to convert the first frame rate into the second frame rate by reading out the stored frames of the plurality of images according to an FRC schedule, to convert the first frame rate into the second frame rate by reading out the stored frames of the plurality of images repeatedly, and to mix the plurality of images which are converted into the second frame rate by reading out the frames according to the FRC schedule, with the plurality of images which are converted into the second frame rate by reading out the frames repeatedly.

13. The image outputting apparatus of claim 12, wherein the FRC circuitry is configured to compensate for a motion by generating an interpolation frame with respect to at least one image from among the plurality of images mixed.

14. The image outputting apparatus of claim 11, further comprising a storage configured to store frames of the plurality of images having the first frame rate, and
wherein the FRC circuitry is configured to read out the stored frames of the plurality of images according to an FRC schedule, to generate the interpolation frame, and to convert the first frame rate into the second frame rate, the FRC circuitry further configured to read out the stored frames of the plurality of images repeatedly and convert the first frame rate into the second frame, and further configured to mix the plurality of images which has the generated interpolation frame and are converted into the second frame rate, with the plurality of images which are converted into the second frame rate by reading out the frames repeatedly.

15. The image outputting apparatus of claim 12, wherein the FRC circuitry is configured to mix the plurality of images using frames which are read out according to the FRC schedule with respect to at least one image from among the plurality of images, and frames which are read out repeatedly with respect to the other images except for the at least one image from among the plurality of images.

16. The image outputting apparatus of claim 11, further comprising user input circuitry configured to receive a user input, and
wherein the FRC circuitry is configured to select at least one image from among the plurality of images based on a received user input, or to select based on image formation.

17. The image outputting apparatus of claim 16, wherein, when at least one of the plurality of images is outputted from a graphic domain of an application, the FRC circuitry is configured to select in a certain form based on a received user input.

18. The image outputting apparatus of claim 16, wherein the image information is at least one of motion vector information, film information, panning information, pattern information, fallback information, and scene change information.

19. The image outputting apparatus of claim 11, wherein the FRC circuitry is configured to extract a motion vector with respect to at least one of the plurality of images, and to generate the interpolation frame using the extracted motion vector.

20. The image outputting apparatus of claim 19, wherein the FRC circuitry is configured to select two or more images from among the plurality of images, to process the selected two or more images as separate areas, and to extract a motion vector from each of the areas.
